(19) United States
(12) Patent Application Publication
(10) Pub. No.: US 2010/0205104 A1
(43) Pub. Date: Aug. 12, 2010

(54) METHOD FOR OPERATING A SHIPPING PROCESS WITHIN A LOGISTICS SYSTEM

(75) Inventor: Brian Johnson, Surprise, AZ (US)

Correspondence Address: International IP Law Group, P.O. BOX 691927, HOUSTON, TX, 77269-1927, US

(73) Assignee: Deutsche Post AG, Bonn (DE)

(21) Appl. No.: 12/679,578

(22) PCT Filed: Sep. 9, 2008
(86) PCT No.: PCT/EP2008/007353

§ 371 Date: Mar. 23, 2010

Related U.S. Application Data
(60) Provisional application No. 60/995,029, filed on Sep. 24, 2007.

(51) Int. Cl. G06Q 50/00; G06F 15/16; H04L 9/00; G06Q 10/00

(52) U.S. Cl. 705/333; 709/219; 713/150; 705/336; 235/375

(57) ABSTRACT

There is provided an exemplary method for operating a shipping process within a logistics system. An exemplary logistics system includes a first client and a shipping station that comprises a second client. Both the first client and the second client are connected to a server. A shipment may be deposited at the shipping station. The exemplary method comprises receiving identification and/or authentication data on the shipment via the first client and forwarding the data to the server. The exemplary method also comprises processing the data and preparing a pre-configuration of the shipping process. The pre-configuration of the shipping process is forwarded to the second client. The pre-configuration of the shipping process via the second client may be supplemented when the shipment is deposited at the shipping station.

The invention relates to a method for operating a shipping process within a logistics system as well a to a corresponding logistics system.

### BACKGROUND AND STATE OF THE ART

Methods and systems for depositing goods that an addressee wishes to return to a deliverer are known from the state of the art. These methods provide for identifying the addressee at the shipping station, after which he can deposit the shipment in a compartment of the shipping station. The addressee also enters the address data of a deliverer who is authorized to have access to the shipment. The deliverer subsequently identifies himself at the system and collects the shipment.

### DESCRIPTION OF THE INVENTION

The objective of the invention is to provide a method for depositing shipments, whereby the convenience and usability for users are increased. Furthermore, safeguards against fraudulent use during the handling of the shipments are improved.

According to the invention, this objective is achieved by a method with the features of the independent claim 1. The objective is further archived by a corresponding logistics system. Additional advantageous embodiments of the invention ensue from the dependent claims.

The method for operating a shipping process within a logistics system according to the invention comprises a first client and a shipping station with a second client, both clients connected to a server, wherein a shipment is deposited at the shipping station, and is characterized by the following steps:
receiving identification and/or authentication data on the shipment via the first client and forwarding the data to the server,
processing the data and preparing a pre-configuration of the shipping process,
forwarding the pre-configuration of the shipping process to the second client,
supplementing the pre-configuration of the shipping process via the second client when the shipment is deposited at the shipping station.

By this method of operating a shipping process most aspects of registration and transfer of information have been transacted when it comes to the physical transfer of the item to be shipped, i.e. the shipment, by depositing the shipment at a shipping station. Registration and transfer of information are often very time consuming and error-prone. By preponing these aspects and transmitting them via the first client, several checking and support tools can be offered to a customer. These checking and support tools will cause an unnecessary delay of time when offered and used during the deposit of the shipment at the shipping station.

In a preferred embodiment of the method a terminal for the first client is located outside the shipping station.

Locating the terminal outside the shipping station includes the possibility for a customer to prepare the shipment of one or several items at home or even on the way by means of a mobile terminal. This provides a maximum of convenience and flexibility for a customer and will have time saving effects on the flow of work in a shipping station.

In a further preferred embodiment the first client is connected to the server via a computer network, preferably the Internet. In this case the first client is a browser, a web browser, for example.

The pre-configuration advantageously comprises the pre-configuration of documents and/or a shipping schedule.

T pre-configuration of documents and/or a shipping schedule may also include a complete configuration in some cases. Examples of documents are waybills, declarations, invoices, receipts etc. A shipping schedule may include a projected routing, a scheduled transport means, transit stops, time and place of delivery, constraints caused by deterioration of a shipment or deadlines etc.

The pre-configuration especially comprises a shipping schedule with information on time and place of a delivery of a shipment.

Furthermore according to a preferred embodiment of the method, the identification and/or authentication data on the shipment received via the first client comprises an indication of an item to be shipped.

Preferably, the step of supplementing the pre-configuration via the second client comprises the step of a declaration of an item to be shipped, for example by a confirmation of the indicated item to be shipped via the first client. But it is as well possible for a customer to make changes on indicated items. This might be a little more time consuming because changes in the pre-configuration are necessary then.

A further preferred embodiment provides an encryption of the identification and/or authentication data on the shipment before forwarding the data from the first client to the server.

In a very preferred embodiment of the invention the identification and/or authentication data on the shipment comprises customized data related to a certain user and/or shipment profile.

An authentication might be required when receiving identification and/or authentication data on the shipment via the first client. An authentication might be required as well when supplementing the pre-configuration of the shipping process via the second client.

The term authentication data on the shipment usually refers to a customer who is the client corresponding to this shipment. The term authentication data on the shipment reflects the fact that one customer might authenticate with different identities dependent on a specific process. But for one shipment a corresponding set of authentication data is unique.

A special embodiment of an authentication process is performed in two steps:
receiving identification and/or authentication data on the shipment via the first client comprises a first authentication step and
supplementing the pre-configuration of the shipping process via the second client comprises a second authentication step.

By an authentication process in two steps preferably at different terminals a double check against errors and fraudulent use is provided. Furthermore the authentication process might be split in a more time consuming routine at a terminal at home and in a less time consuming routine in a terminal at the shipping station.

In a further advantageous embodiment receiving identification and/or authentication data on the shipment via the first client comprises transferring at least a part of the data to a transponder attached to the shipment and supplementing the pre-configuration of the shipping process via the second client comprises scanning the transponder at the shipping station.

In this case a comparison between the data stored in the transponder and the data available via the second client can be performed which is a basis for a further check for correct shipment data.

It is also an objective of the invention to provide a logistics system for operating a shipping process with a first client and a shipping station comprising a second client, both clients connected to a server, wherein a shipment is deposited at the shipping station, which is characterized by the following features:
the first client adapted to receive identification and/or authentication data on the shipment and forward the data to the server,
the server adapted to process the data, prepare a pre-configuration of the shipping process and to forward the pre-configuration of the shipping process to the second client,
the second client adapted to receive a supplement to the pre-configuration of the shipping process when the shipment is deposited at the shipping station.

### BRIEF DESCRIPTION OF THE DRAWINGS

FIG. 1 a first client used for operating a shipping process within a logistics system,

FIG. 2 a schematic depiction of a logistics system.

### DETAILED DESCRIPTION OF THE DRAWINGS

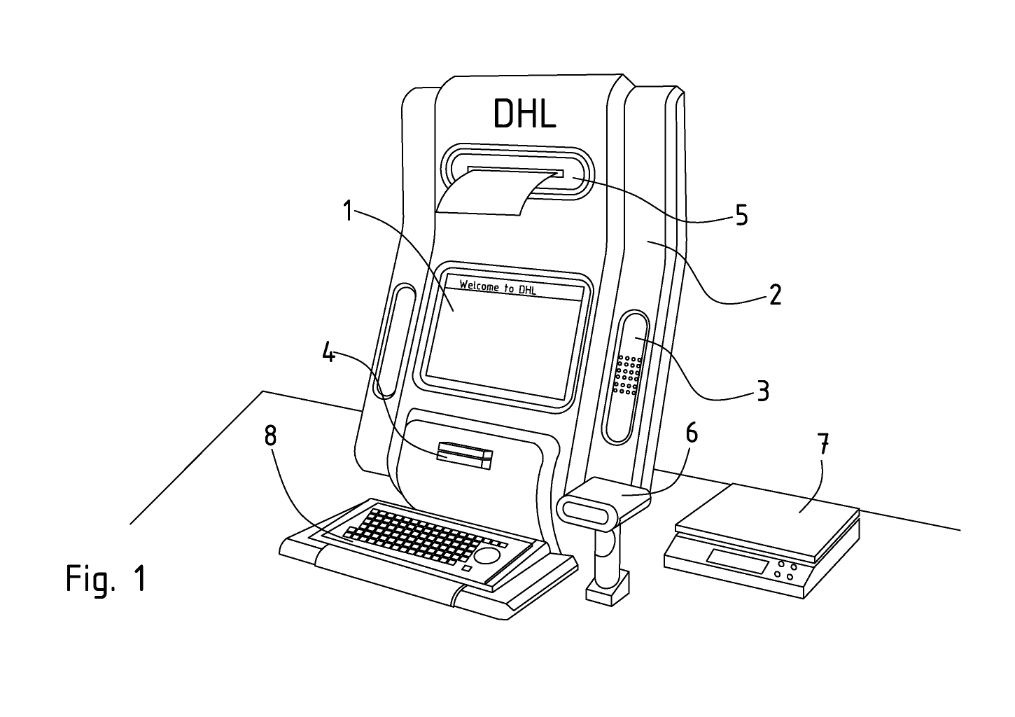

FIG. 1 shows a first client comprising a terminal 2 with a display 1, a card reader 4, a speaker phone 3, a printer 5, a scanner 6, a scale 7 and a keypad 8. The display 1 is preferably an LCD monitor designed as a flat screen. The screen may be a touch screen.

In order to facilitate communication between a user of the terminal 2 and a service station of a logistics system provider, the terminal contains the speaker phone 3. The user and the service station of the logistics system provider are not illustrated in FIG. 1.

In order to carry out payment procedures the terminal 2 comprises the card reader 4, preferably a credit card reader. Card readers for other types of cards are possible as well, for example smartcard readers for authentication purposes.

Labels, waybills, invoices, receipts etc. are printed by the printer 5. Advantageously the printer 5 is incorporated in the terminal 2.

The scanner 6 is located at the terminal 2 and preferably adapted to read a barcode and/or matrix code attached to an item to be shipped. There may also be an RFID-reader (Radio Frequency IDentification) located at the terminal 2 to read an RFID-tag attached to an item to be shipped. The scanner 6 is enabled to read coded information, e.g. identification and/or authentication data on a shipment.

The scale 7 allows a weighing of an item to be shipped. The scale 7 and the terminal 2 are connected via an appropriate data link. The data link can be carried out by a wire or be implemented as a wireless solution, e.g. Bluetooth®.

To facilitate a choice of options for a user the terminal 2 comprises the keypad 8.

The invention includes a high level of user service because suggestions and complaints of users are received by the speaker phone 3. Thereby a direct line of communication is offered from a user to various departments of a logistics system provider.

In a further preferred embodiment of the invention the terminal 2 provides a notification system to a user referring to service issues as system outages or other situations that may affect the user's shipping activities. On-screen and/or audio alerts will show up at the terminal 2 and give a user adequate time to make alternative shipment arrangements.

The terminal 2 provides a convenient way for users to inform a logistics provider in case a regularly scheduled pickup is required or not required. This feature will save a courier's time. At pre-determined intervals, e.g. 2 hours, 1 hour, 30 minutes, prior to the courier's scheduled pickup time, an on-screen and/or audio alert is displayed in order to inform a user that he has ordered no shipment for the day. The user will then be given an option to cancel the pickup that is scheduled for the day. If the pickup is cancelled, the courier and/or logistics provider station is notified via email, SMS messaging etc.

The terminal 2 may incorporate a functionality of scrolling a news bar on the display 1 with important user information concerning marketing communications, advertising opportunities, shipping updates etc.

The logistics system may further provide for real-time tracking on all shipments of a user, an auto-print/email functionality for successful shipping notification, a visual map display for tracked items, e.g. via Google Earth Interface, etc. at the terminal 2.

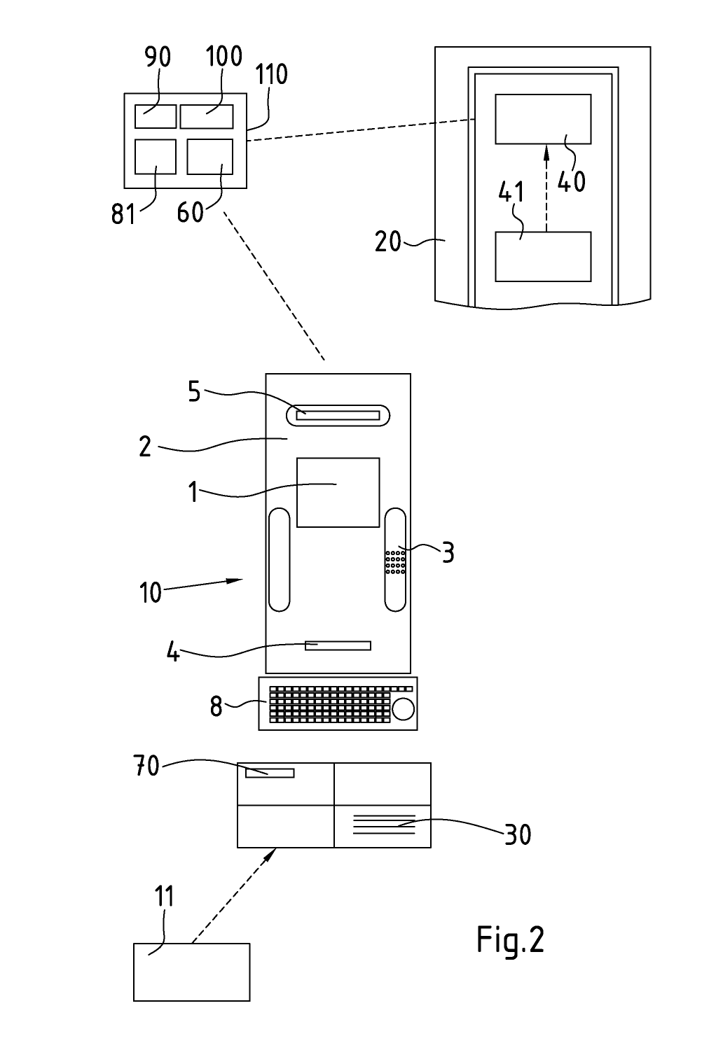

FIG. 2 shows a schematic depiction of a logistics system with different components and users. The logistics system comprises a first client 10 with a user 11 who wants to send a shipment 30, a shipping station 20 comprising a second client 40 with an employee 41 as another user and a server 110.

The first client 10 is illustrated more detailed in FIG. 1. The first client 10 in FIG. 2 comprises the terminal 2 with the display 1, the card reader 4, the speaker phone 3, the printer 5 and the keypad 8. The first client 10 is placed outside a shipping station 20. Preferably the first client 10 comprises a computer terminal which is connected to the Internet.

The second client 40 is located in the shipping station 20 which is integrated in the logistics system.

The term “logistics system” is used in its broadest sense and includes systems, which contain means and/or arrangements for carrying out the transport and/or handling of items, especially postal deliveries. These items are shipped from the shipping station 20 to a destination which is not illustrated in FIG. 2. An item to be shipped is called shipment 30.

The logistics system may comprise several types of shipping stations 20. Examples of the shipping stations 20 are electronic parcel compartment systems, drop boxes, post office counters etc.

The user 11 wants to send the shipment 30 to a receiver via a logistics service provider. The user 11 might have received the shipment 30 as original addressee and wants to send the shipment 30 as a return shipment 30.

In order access the operating functions at the first client 10 the user 11 has to authenticate. This can for example be accomplished by entering a PIN code in the keypad 8 and/or by inserting a personalized user card in the card reader 4.

The user data is acquired at the terminal 2 by at least one item of the following group: the card reader 4, the keypad 8, a touch screen and a scanner.

It is convenient for the user 11 to place the terminal 2 outside the shipping station 20. This allows the user 11 to register early and to facilitate a registration of the shipment 30 at the shipping station 20. However, it is also possible to integrate the terminal 2 in the shipping station 20.

If the terminal 2 is located away from the shipping station 20, it is advantageous to connect the terminal 2 and the shipping station 20 electronically, e.g. through the Internet.

However, it is also possible that no connection between the terminal 2 and the shipping station 20 exists. In this case it is preferred to store the information acquired at the terminal 2 in a key tag. The key tag allows a facilitated exchange of information at the shipping station 20 and accelerates a procedure of registering the shipment 30.

It is especially preferable to acquire user data at the terminal 2. The acquired user data is associated with a user profile in order to authenticate. An authentication unit 60 can be located within the shipping station 20 or can be located on the server 110 and is for example connected to the other components of the logistics system online. An online connection can be realized permanent or temporary.

The server 110 preferably manages data exchange for several shipping stations. The data is advantageously stored and managed in a database 90. In addition to user profiles, the managed data may also include data relating to the logistics service providers and all kind of status data. The server 110 might comprise a further storage means 81 besides the database 90.

In an especially preferred embodiment, the server 110 also comprises a notification component 100 for a transmission of messages between the shipping station 20, the server 110, the user 11, the employee 41 and the logistics service providers. The notification component 100 may send automated messages via SMS (Short Message Service) or email.

Information on the shipment 30 is preferably provided in the form of an imprint, a sticker or a transponder (RFID) on the shipment. The shipment information can be generated, for example, by a numeric string or a barcode. If the shipment information is formed by a numeric string, the numeric string can also be entered by the user 11 or the employee 41 using an input means such as a keypad 8 or a touch screen.

The validity of the shipment information acquired via the second client 40 is verified by a comparison with the stored information received via the first client 10 and/or stored in the transponder 70. The data and also the appertaining authentication unit 60 can be arranged within the shipping station 20 or in the server 110. The verification can be carried out, for example, on the basis of a number of digits and/or on the basis of checksum logic. If the verification shows that the shipment information is invalid, the procedure is terminated and a message to this effect is displayed to the employee 41. Invalid shipment information is present, for example, if incorrect data formats were acquired, which is an indication of an attempted fraudulent use. Moreover, if a logistics service provider withdraws from the shipping station 20, this could be a case of obsolete shipment information that no longer allows the placing of a shipping order.

The term verification as used with the invention may also include an authentication.

If the verification indicates that the acquired shipment information is valid and can be associated with a logistics service provider, then a compartment in the shipping station 20 is released for depositing the shipment 30 and it is closed after the shipment 30 has been deposited there. A compartment can be selected, for example, as a function of the size of the shipment 30. If the payment of an additional charge fee is required in order to deposit the shipment 30, then payment verification can be carried out before a compartment is opened. This is possible, for example, by reading in payment information such as stamps or value coupons on the shipment 30. Payment functions such as coin slots, reading means for cash cards, credit cards etc. or reading means via cell phones can be provided in order to transact the required payments.

The acquired shipment information is stored in the storage means 81. The storage means 81 can likewise be located within the shipping station 20 or in the server 110, as shown in FIG. 1. The shipment information is associated with a logistics service provider.

In an especially preferred embodiment of the invention, a message is transmitted by the notification component 100 to a logistics service provider indicating that a user 11 has deposited the shipment 30 for pickup. In addition to information on the shipment 30 and the user 11 the message can also contain information on the time of the deposit and/or the size of the shipment 30. Preferably, several messages about deposited shipments are bundled in a collective message. This can be done, for example, at fixed intervals such as days or weeks.

In a preferred embodiment access rights of the user 11 are verified in a verification means belonging to the authentication unit 60, by associating the acquired user data with a stored user profile.

In a preferred embodiment the acquired user data are stored in a key tag.

The procedure at the shipping station 20 is terminated if the verification means yields a negative result of the verification. If the verification means yields a positive result of the verification, then access is granted to operating functions at the shipping station 20. Here, a distinction can be made between general operating functions of the shipping station 20 and special operating functions for handling the shipment 30. For example, all of the functions except depositing the item as shipment and/or creating labels for a shipment can be displayed and made available to the user 11 if the verification of the user data has shown that the user in question does not have the proper rights.

It is also advantageous for the user data to be read in from a user card at the terminal 2.

The method according to the invention has several advantages. For one thing, it allows the verification of user profiles before the shipment 30 is deposited, which further safeguards the operator of the shipping station 20 against fraudulent use. If the user 11 is not authorized to deposit the shipment 30, then this particular operating function is not offered to him.

Secondly, the security of the handling of shipments 30 is enhanced in that the shipment information is acquired and evaluated in a first step at the terminal 2 by the user 11 as well as in a second step when depositing the shipment 30 at the shipping station 20. Hence, the user 11 may only deposit shipments that are provided with a permissible shipment code of a logistics service provider. The shipment code is once again acquired at the shipping station 20 so as to prevent the user 11 from previously causing an incorrect shipment code to be acquired. Since the data is once again compared, cases of fraudulent use are avoided. At the time of the deposit, no shipment information is acquired that is not present on the deposited shipment 30.

List of Reference Numerals:

| | |
|---|---|
| 1 | display |
| 2 | terminal |
| 3 | speaker phone |
| 4 | card reader |
| 5 | printer |
| 6 | scanner |
| 7 | scale |
| 8 | keypad |
| 10 | first client |
| 11 | user |
| 20 | shipping station |
| 30 | shipment |
| 31 | user |
| 40 | second client |
| 41 | employee |
| 60 | authentication unit |
| 70 | transponder |
| 81 | storage means |
| 90 | database |
| 100 | notification component |
| 110 | server |

1-13. (canceled)

14. A method for operating a shipping process within a logistics system with a first client and a shipping station comprising a second client, both clients connected to a server, wherein a shipment is deposited at the shipping station, the method comprising:
receiving identification and/or authentication data on the shipment via the first client and forwarding the data to the server;
processing the data and preparing a pre-configuration of the shipping process;
forwarding the pre-configuration of the shipping process to the second client; and
supplementing the pre-configuration of the shipping process via the second client when the shipment is deposited at the shipping station.

15. The method recited in claim 14, wherein a terminal for the first client is located outside the shipping station.

16. The method recited in claim 14, wherein the first client is connected to the server via the Internet.

17. The method recited in claim 14, wherein the pre-configuration comprises the pre-configuration of documents and/or a shipping schedule.

18. The method recited in claim 14, wherein the pre-configuration comprises a shipping schedule with information on time and place of a delivery of the shipment.

19. The method recited in claim 14, wherein the identification and/or authentication data on the shipment comprises an indication of an item to be shipped.

20. The method recited in claim 14, wherein the step of supplementing the pre-configuration comprises the step of a declaration of the item to be shipped.

21. The method recited in claim 14, wherein at least a part of the identification and/or authentication data on the shipment is encrypted before forwarding the data from the first client to the server.

22. The method recited in claim 14, wherein the identification and/or authentication data on the shipment comprises customized data related to a user and/or shipment profile.

23. The method recited in claim 14, wherein receiving identification and/or authentication data on the shipment via the first client comprises a first authentication step and supplementing the pre-configuration of the shipping process via the second client comprises a second authentication step.

24. The method recited in claim 14, wherein receiving identification and/or authentication data on the shipment via the first client comprises transferring at least a part of the data to a transponder attached to the shipment.

25. The method recited in claim 24, wherein supplementing the pre-configuration of the shipping process via the second client comprises scanning the transponder at the shipping station.

26. A logistics system for operating a shipping process, the logistics system comprising:
a server;
a first client connected to the server, the first client being adapted to receive identification and/or authentication data on the shipment and forward the data to the server;
a shipping station that comprises a second client connected to the server, the shipment being deposited at the shipping station;
the server being adapted to process the data, prepare a pre-configuration of the shipping process and to forward the pre-configuration of the shipping process to the second client; and
the second client adapted to receive a supplement to the pre-configuration of the shipping process when the shipment is deposited at the shipping station.

27. A system for operating a shipping process within a logistics system with a first client and a shipping station comprising a second client, both clients connected to a server, wherein a shipment is deposited at the shipping station, the method comprising:
means for receiving identification and/or authentication data on the shipment via the first client and forwarding the data to the server;
means for processing the data and preparing a pre-configuration of the shipping process;
means for forwarding the pre-configuration of the shipping process to the second client; and
means for supplementing the pre-configuration of the shipping process via the second client when the shipment is deposited at the shipping station.
